(19) United States
(12) Patent Application Publication
(10) Pub. No.: US 2026/0109645 A1
(43) Pub. Date: Apr. 23, 2026

(54) METHOD AND SYSTEMS FOR PROCESSING FLY ASH TO REDUCE A CARBON CONTENT THEREOF

(71) Applicant: ECO MATERIAL TECHNOLOGIES IP LLC, SOUTH JORDAN, UT (US)

(72) Inventors: Dwayne A. Johnson, Fort Mill, SC (US); Theodore Moskal, Ormond Beach, FL (US)

(21) Appl. No.: 19/365,295

(22) Filed: Oct. 22, 2025

Related U.S. Application Data
(60) Provisional application No. 63/710,289, filed on Oct. 22, 2024.

(51) Int. Cl. C04B 18/08; B07B 1/00; B09B 3/25; B09B 3/38; B09B 3/40; B09B 101/30; C04B 24/02

(52) U.S. Cl. CPC C04B 18/08; B07B 1/00; B09B 3/25; B09B 3/38; B09B 3/40; C04B 24/023; B09B 2101/30

(57) ABSTRACT

A method for processing fly ash to reduce a carbon content thereof is disclosed. The disclosed method may include drying a batch of wet fly ash and separating it into first and second streams of dried fly ash, with the second stream then undergoing classification to remove oversized particles and bottom ash therefrom and thermal treatment to offload carbon therefrom. The method also may include mixing (A) the first stream of dried fly ash and (B) the classified and thermally treated second stream of dried fly ash to produce (C) a processed fly ash mixture having a carbon content in the range of about 3.0-6.0 wt %. In some cases, additive(s) optionally may be added to the processed fly ash mixture, for example, to further adjust its loss on ignition (LOI) to a targeted range. Also disclosed are several systems embodying such methodology.

### CROSS-REFERENCE TO RELATED APPLICATIONS

This patent application claims the benefit of U.S. Provisional Patent Application No. 63/710,289, titled “Method and Systems for Offloading Carbon from Fly Ash,” filed on Oct. 22, 2024, which is herein incorporated by reference in its entirety.

### FIELD OF THE DISCLOSURE

The present disclosure relates to fly ash processing and, more particularly, to processing fly ash to reduce a carbon content thereof.

### BACKGROUND

Fly ash is the finely divided residue that results from the combustion of ground or powdered coal that is carried by flue gases. Fly ash is the most common supplementary cementitious material used to partially replace cement in the manufacturing of concrete and concrete products. ASTM C618, the standard specification for fly ash and raw or calcined natural pozzolans for use in concrete, provides minimum quality requirements for fly ash to be used in concrete. Among the requirements for fly ash laid out in ASTM C618 is a carbon content, measured as loss on ignition (LOI), of 6% max. In many cases, market acceptance requires fly ash to have LOI well below the 6% threshold laid out in C618. Fly ash having LOI greater than 6% is typically considered undesirable for use in concrete in concrete products.

### SUMMARY

The subject matter of this application may involve, in some cases, interrelated products, alternative solutions to a particular problem, and/or a plurality of different uses of a single system or article.

A first example embodiment provides a method for processing fly ash, the method including: separating a batch of fly ash into: (a) a first stream of dried fly ash; and (b) a second stream of dried fly ash; classifying the second stream of dried fly ash; thermally treating the classified second stream of dried fly ash to reduce a carbon content thereof; and mixing the first stream of dried fly ash and the classified and thermally treated second stream of dried fly ash to produce a processed fly ash mixture.

In some cases, the first stream of dried fly ash has a carbon content which is lower than that of the batch of fly ash. In some cases, the first stream of dried fly ash has a carbon content that is 0.75-1.25 points lower than that of the batch of fly ash. In some cases, the first stream of dried fly ash has a carbon content in the range of about 2.0-18.0 wt %. In some cases, the first stream of dried fly ash has a carbon content in the range of about 5.0-10.0 wt %±3.0 wt %. In some cases, the first stream of dried fly ash has a fines content which is less than that of the batch of fly ash. In some cases, the first stream of dried fly ash has a fines content in the range of about 10.0-34.0 wt %. In some cases, the first stream of dried fly ash has a fines content of about 18.0 wt %±8.0 wt %. In some cases, the first stream of dried fly ash consists essentially of particles that do not pass through a 325-mesh screen.

In some cases, the carbon content of the second stream of dried fly ash is equal to or greater than that of the batch of fly ash. In some cases, the carbon content of the second stream of dried fly ash is in the range of about 3.0-20.0 wt %. In some cases, the carbon content of the second stream of dried fly ash is in the range of about 6.0-15.0 wt %±3.0 wt %. In some cases, the carbon content of the second stream of dried fly ash is 1.0-3.0 points higher than that of the batch of fly ash.

In some cases: the first stream of dried fly ash has a carbon content in the range of about 2.0-18.0 wt %; and the carbon content of the second stream of dried fly ash is in the range of about 3.0-20.0 wt %. In some cases: the first stream of dried fly ash has a carbon content in the range of about 5.0-10.0 wt %±3.0 wt %; and the carbon content of the second stream of dried fly ash is in the range of about 6.0-15.0 wt %±3.0 wt %.

In some cases, before separating the batch of fly ash into the first stream of dried fly ash and the second stream of dried fly ash, the method further includes: drying the batch of fly ash. In some instances, at least one of: (a) before drying, the batch of fly ash has a moisture content in the range of about 5.0-25.0 wt %; and (b) after drying, the batch of fly ash has a moisture content in the range of about 5.0 wt % or less. In some instances, both: (a) before drying, the batch of fly ash has a moisture content in the range of about 5.0-25.0 wt %; and (b) after drying, the batch of fly ash has a moisture content in the range of about 5.0 wt % or less. In some instances, after drying, the batch of fly ash has a moisture content of about 1.5 wt %±0.5 wt %. In some instances, after drying, the batch of fly ash has a maximum moisture content of about 1.0 wt %±0.25 wt %. In some instances, drying the batch of fly ash at least one of: (a) utilizes a rotary dryer; and (b) is performed at a burner temperature in the range of about 1,000-2,000° F. In some instances, drying the batch of fly ash both: (a) utilizes a rotary dryer; and (b) is performed at a burner temperature in the range of about 1,000-2,000° F. In some instances, the burner temperature is in the range of about 1,100-1,800° F. In some instances, the burner temperature is in the range of about 1,500° F.±50° F.

In some cases, before drying the batch of fly ash, the method further includes: screening the batch of fly ash. In some instances, the batch of fly ash is screened to a size in the range of about 0.25-0.75 in. In some instances, the batch of fly ash is screened to a size of about 0.5 in ±0.15 in.

In some cases, the second stream of dried fly ash is classified to remove particles having a size of about 15.0 μm or greater. In some cases, the second stream of dried fly ash is classified to remove particles having a size of about 30.0 μm or greater. In some cases, the second stream of dried fly ash is classified to remove particles having a size of about 45.0 μm or greater. In some cases, the second stream of dried fly ash is classified to remove particles having a size of about 60.0 μm or greater.

In some cases, at least one of: (a) the batch of fly ash has a carbon content in the range of about 2.0-18.0 wt %; and (b) the carbon content of the classified and thermally treated second stream of dried fly ash is in the range of about 4.0 wt % or less. In some cases, both: (a) the batch of fly ash has a carbon content in the range of about 2.0-18.0 wt %; and (b) the carbon content of the classified and thermally treated second stream of dried fly ash is in the range of about 4.0 wt % or less. In some cases, the carbon content of the classified and thermally treated second stream of dried fly ash is about 2.5 wt %±0.75 wt %. In some cases, thermally treating the classified second stream of dried fly ash is performed at a burner temperature in the range of about 1,000-1,800° F. In some cases, thermally treating the classified second stream of dried fly ash is performed at a burner temperature of about 1,200° F.±150° F. In some cases, the processed fly ash mixture has a carbon content in the range of about 3.0-6.0 wt %. In some cases, the processed fly ash mixture has a carbon content in the range of about 4.0 wt %±0.75 wt %.

In some cases, the method further includes: adding at least one additive to the processed fly ash mixture. In some instances, adding the at least one additive to the processed fly ash mixture includes: spraying the at least one additive onto the processed fly ash mixture. In some instances, the at least one additive is added at a dosage in the range of about 0.1-2.0 lbs./ton of the processed fly ash mixture. In some instances, the at least one additive is configured to passivate an adsorption capacity of any unburned carbon content within the processed fly ash mixture. In some instances, the at least one additive is configured to preferentially adsorb onto carbon surfaces within the processed fly ash mixture and reduce an ability thereof to adsorb air entrainment agents in concrete. In some instances, the at least one additive includes a liquid reagent. In some instances, the at least one additive includes an ethoxylated alcohol. In some instances, the ethoxylated alcohol has at least one of: (a) n-octanol-water partition coefficient (log K_{ow}) values in the range of −5 to +20; and (b) hydrophilic-lipophilic balance (HLB) values in the range of −50 to +20. In some instances, the n-octanol-water partition coefficient (log K_{ow}) values are in the range of −2 to +2. In some instances, the ethoxylated alcohol has both: (a) n-octanol-water partition coefficient (log K_{ow}) values in the range of −5 to +20; and (b) hydrophilic-lipophilic balance (HLB) values in the range of −50 to +20. In some instances, the n-octanol-water partition coefficient (log K_{ow}) values are in the range of −2 to +2. In some instances, the at least one additive includes: an ethoxylated alcohol; and propylene glycol. In some instances, at least one of: (a) the ethoxylated alcohol constitutes between 40.0-80.0 wt % of the at least one additive; and (b) the propylene glycol constitutes between 5.0-30.0 wt % of the at least one additive. In some instances, both: (a) the ethoxylated alcohol constitutes between 40.0-80.0 wt % of the at least one additive; and (b) the propylene glycol constitutes between 5.0-30.0 wt % of the at least one additive. In some instances, the at least one additive further includes water. In some instances, the water constitutes between 10.0-30.0 wt % of the at least one additive.

A second example embodiment provides a system. The system includes a first stage or module configured to separate a batch of fly ash into: (a) a first stream of dried fly ash; and (b) a second stream of dried fly ash. The system further includes a second stage or module configured to classify the second stream of dried fly ash The system further includes a third stage or module configured to thermally treat the classified second stream of dried fly ash to reduce a carbon content thereof. The system further includes a fourth stage or module configured to mix the first stream of dried fly ash and the classified and thermally treated second stream of dried fly ash to produce a processed fly ash mixture.

In some cases, the first stream of dried fly ash has a carbon content which is lower than that of the batch of fly ash. In some cases, the first stream of dried fly ash has a carbon content that is 0.75-1.25 points lower than that of the batch of fly ash. In some cases, the first stream of dried fly ash has a carbon content in the range of about 2.0-18.0 wt %. In some cases, the first stream of dried fly ash has a carbon content in the range of about 5.0-10.0 wt %±3.0 wt %. In some cases, the first stream of dried fly ash has a fines content which is less than that of the batch of fly ash. In some cases, the first stream of dried fly ash has a fines content in the range of about 10.0-34.0 wt %. In some cases, the first stream of dried fly ash has a fines content of about 18.0 wt %±8.0 wt %. In some cases, the first stream of dried fly ash consists essentially of particles that do not pass through a 325-mesh screen.

In some cases, the carbon content of the second stream of dried fly ash is equal to or greater than that of the batch of fly ash. In some cases, the carbon content of the second stream of dried fly ash is in the range of about 3.0-20.0 wt %. In some cases, the carbon content of the second stream of dried fly ash is in the range of about 6.0-15.0 wt %±3.0 wt %. In some cases, the carbon content of the second stream of dried fly ash is 1.0-3.0 points higher than that of the batch of fly ash.

In some cases: the first stream of dried fly ash has a carbon content in the range of about 2.0-18.0 wt %; and the carbon content of the second stream of dried fly ash is in the range of about 3.0-20.0 wt %. In some cases: the first stream of dried fly ash has a carbon content in the range of about 5.0-10.0 wt %±3.0 wt %; and the carbon content of the second stream of dried fly ash is in the range of about 6.0-15.0 wt %±3.0 wt %.

In some cases, the first stage or module is further configured to dry the batch of fly ash before separating the batch of fly ash into the first stream of dried fly ash and the second stream of dried fly ash. In some instances, at least one of: (a) before drying via the first stage or module, the batch of fly ash has a moisture content in the range of about 5.0-25.0 wt %; and (b) after drying via the first stage or module, the batch of fly ash has a moisture content in the range of about 5.0 wt % or less. In some instances, both: (a) before drying via the first stage or module, the batch of fly ash has a moisture content in the range of about 5.0-25.0 wt %; and (b) after drying via the first stage or module, the batch of fly ash has a moisture content in the range of about 5.0 wt % or less. In some instances, after drying via the first stage or module, the batch of fly ash has a moisture content of about 1.5 wt %±0.5 wt %. In some instances, after drying via the first stage or module, the batch of fly ash has a maximum moisture content of about 1.0 wt %±0.25 wt %. In some instances, drying the batch of fly ash via the first stage or module at least one of: (a) utilizes a rotary dryer; and (b) is performed at a burner temperature in the range of about 1,000-2,000° F. In some instances, drying the batch of fly ash via the first stage or module both: (a) utilizes a rotary dryer; and (b) is performed at a burner temperature in the range of about 1,000-2,000° F. In some instances, the burner temperature is in the range of about 1,100-1,800° F. In some instances, the burner temperature is in the range of about 1,500° F.±50° F. In some cases, the first stage or module is further configured to screen the batch of fly ash before drying the batch of fly ash. In some instances, the batch of fly ash is screened via the first stage or module to a size in the range of about 0.25-0.75 in. In some instances, the batch of fly ash is screened via the first stage or module to a size of about 0.5 in±0.15 in.

In some cases, the second stream of dried fly ash is classified via the second stage or module to remove particles having a size of about 15.0 μm or greater. In some cases, the second stream of dried fly ash is classified via the second stage or module to remove particles having a size of about 30.0 μm or greater. In some cases, the second stream of dried fly ash is classified via the second stage or module to remove particles having a size of about 45.0 μm or greater. In some cases, the second stream of dried fly ash is classified via the second stage or module to remove particles having a size of about 60.0 μm or greater.

In some cases, at least one of: (a) the batch of fly ash has a carbon content in the range of about 2.0-18.0 wt %; and (b) the carbon content of the classified and thermally treated second stream of dried fly ash is in the range of about 4.0 wt % or less. In some cases, both: (a) the batch of fly ash has a carbon content in the range of about 2.0-18.0 wt %; and (b) the carbon content of the classified and thermally treated second stream of dried fly ash is in the range of about 4.0 wt % or less. In some cases, the carbon content of the classified and thermally treated second stream of dried fly ash is about 2.5 wt %±0.75 wt %. In some cases, thermally treating the classified second stream of dried fly ash via the third stage or module is performed at a burner temperature in the range of about 1,000-1,800° F. In some cases, thermally treating the classified second stream of dried fly ash via the third stage or module is performed at a burner temperature of about 1,200° F.±150° F. In some cases, the processed fly ash mixture has a carbon content in the range of about 3.0-6.0 wt %. In some cases, the processed fly ash mixture has a carbon content in the range of about 4.0 wt %±0.5 wt %.

In some cases, the system further includes a fifth stage or module configured to add at least one additive to the processed fly ash mixture. In some instances, the fifth stage or module is configured to add the at least one additive to the processed fly ash mixture by spraying the at least one additive onto the processed fly ash mixture. In some instances, the at least one additive is added via the fifth stage or module at a dosage in the range of about 0.1-2.0 lbs./ton of the processed fly ash mixture. In some instances, the at least one additive is configured to passivate an adsorption capacity of any unburned carbon content within the processed fly ash mixture. In some instances, the at least one additive is configured to preferentially adsorb onto carbon surfaces within the processed fly ash mixture and reduce an ability thereof to adsorb air entrainment agents in concrete. In some instances, the at least one additive includes a liquid reagent. In some instances, the at least one additive includes an ethoxylated alcohol. In some instances, the ethoxylated alcohol has at least one of: (a) n-octanol-water partition coefficient (log K_{ow}) values in the range of −5 to +20; and (b) hydrophilic-lipophilic balance (HLB) values in the range of −50 to +20. In some instances, the n-octanol-water partition coefficient (log K_{ow}) values are in the range of −2 to +2. In some instances, the ethoxylated alcohol has both: (a) n-octanol-water partition coefficient (log K_{ow}) values in the range of −5 to +20; and (b) hydrophilic-lipophilic balance (HLB) values in the range of −50 to +20. In some instances, the n-octanol-water partition coefficient (log K_{ow}) values are in the range of −2 to +2. In some instances, the at least one additive includes: an ethoxylated alcohol; and propylene glycol. In some instances, at least one of: (a) the ethoxylated alcohol constitutes between 40.0-80.0 wt % of the at least one additive; and (b) the propylene glycol constitutes between 5.0-30.0 wt % of the at least one additive. In some instances, both: (a) the ethoxylated alcohol constitutes between 40.0-80.0 wt % of the at least one additive; and (b) the propylene glycol constitutes between 5.0-30.0 wt % of the at least one additive. In some instances, the at least one additive further includes water. In some instances, the water constitutes between 10.0-30.0 wt % of the at least one additive.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

FIG. 1 is a flow diagram illustrating a method of processing fly ash to reduce a carbon content thereof, in accordance with an embodiment of the present disclosure.

FIG. 2A is a process flow diagram illustrating a system configured for processing fly ash to reduce a carbon content thereof, in accordance with an embodiment of the present disclosure.

FIG. 2B is a process flow diagram illustrating a system configured for processing fly ash to reduce a carbon content thereof, in accordance with another embodiment of the present disclosure.

FIGS. 3A-3C are process flow diagrams illustrating three example instances of operation of a system, which is configured for processing fly ash to reduce a carbon content thereof, on respective batches of raw fly ash having (A) 10% initial LOI with 50% dryer entrainment, (B) 6% initial LOI with 60% dryer entrainment, and (C) 4% initial LOI with 70% dryer entrainment, in accordance with some embodiments of the present disclosure.

FIGS. 4A-4B are process flow diagrams illustrating two example instances of operation of a system, which is configured for processing fly ash to reduce a carbon content thereof, on respective batches of fly ash having (A) a relatively high initial LOI vs. (B) a relatively low initial LOI, in accordance with some embodiments of the present disclosure.

These and other features of the present embodiments will be understood better by reading the following detailed description, taken together with the figures herein described. In the drawings, each identical or nearly identical component that is illustrated in various figures may be represented by a like numeral. For purposes of clarity, not every component may be labeled in every drawing. Furthermore, as will be appreciated in light of this disclosure, the accompanying drawings are not intended to be drawn to scale or to limit the described embodiments to the specific configurations shown. [For instance, while some figures generally indicate straight lines, right angles, and smooth surfaces, an actual implementation of {_; the disclosed techniques} may have less than perfect straight lines and right angles, and some features may have surface topography or otherwise be non-smooth, given real world limitations of {_; fabrication processes}. In short, the figures are provided merely to show example structures.]

### DETAILED DESCRIPTION

A method for processing fly ash to reduce a carbon content thereof is disclosed. The disclosed method may include drying a batch of wet fly ash and separating it into first and second streams of dried fly ash, with the second stream then undergoing classification to remove oversized particles and bottom ash therefrom and thermal treatment to offload carbon therefrom. The method also may include mixing (A) the first stream of dried fly ash and (B) the classified and thermally treated second stream of dried fly ash to produce (C) a processed fly ash mixture having a carbon content in the range of about 3.0-6.0 wt %. In some cases, additive(s) optionally may be added to the processed fly ash mixture, for example, to further adjust its loss on ignition (LOI) to a targeted range. Also disclosed are several systems embodying such methodology. Numerous configurations and variations will be apparent in light of this disclosure.

### General Overview

Fly ash, the finely divided material collected by electrostatic precipitators from the flue gases at coal-fired power plants, has become an essential component of concrete. Concrete proportioned with fly ash shows improved performance not attainable by use of hydraulic cement alone. Fly ash has physical and chemical synergistic effects with hydraulic cement in concrete, the type and extent of which depend on the particle size distribution and chemical composition of the fly ash. Per ASTM C618, fly ash is classified based on its chemical composition into two categories. Generally, class F fly ashes have a predominant alumino-silicate glass phase, which provides pozzolanic properties. Meanwhile, class C fly ashes have a predominant calcium-alumino-silicate glass phase, which is pozzolanic as well as cementitious.

Residual unburned carbon in coal ash interacts with air entraining and other admixtures in concrete and is one of the primary characteristics that determines utilization of coal ash in concrete. To control carbon content, ASTM standards limit loss on ignition (LOI), which value is found by placing the coal ash in a muffle furnace at 750° C. to allow combustion to occur. ASTM C618 requires a LOI of less than 6%, but many specifiers select their own limit. The LOI in coal ash is primarily carbon, but there are additional volatiles that oxidize during testing and contribute to the overall LOI value.

Thus, and in accordance with some embodiments of the present disclosure, a method for processing fly ash to reduce a carbon content thereof is disclosed. The disclosed method may include drying a batch of wet fly ash and separating it into first and second streams of dried fly ash, with the second stream then undergoing classification to remove oversized particles and bottom ash therefrom and thermal treatment to offload carbon therefrom. The method also may include mixing (A) the first stream of dried fly ash and (B) the classified and thermally treated second stream of dried fly ash to produce (C) a processed fly ash mixture having a carbon content in the range of about 3.0-6.0 wt %. In some cases, additive(s) optionally may be added to the processed fly ash mixture, for example, to further adjust its loss on ignition (LOI) to a targeted range. Also disclosed are several systems embodying such methodology.

### Methodology

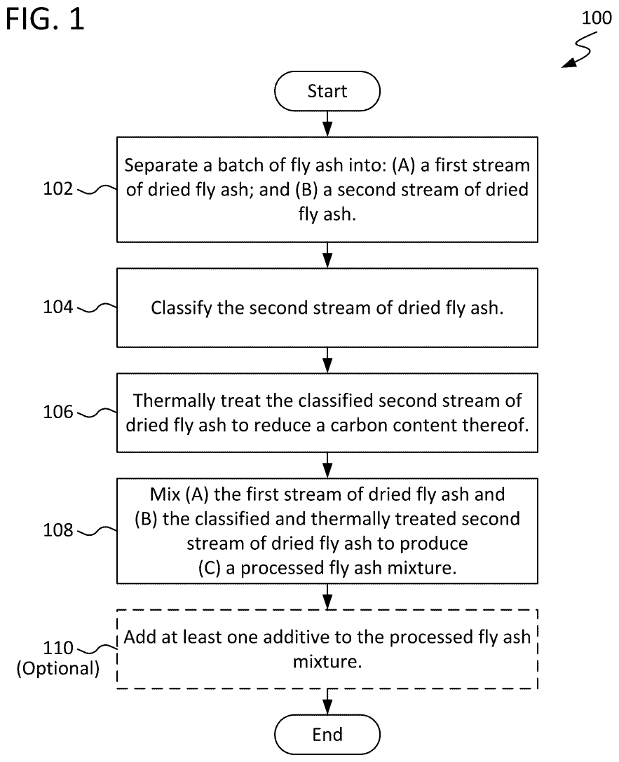

FIG. 1 is a flow diagram illustrating a method 100 of processing fly ash to reduce a carbon content thereof, in accordance with an embodiment of the present disclosure. In performance of method 100, the fly ash utilized may be (or otherwise may include) fly ash (e.g., wet fly ash) having a moisture content in the range of about 5.0-25.0 wt % (e.g., about 5.0-10.0 wt %, about 10.0-15.0 wt %, about 15.0-20.0 wt %, about 20.0-25.0 wt %, or any other sub-range in the range of about 5.0-25.0 wt %). In some cases, the fly ash may have an initial carbon content in the range of about 2.0-18.0 wt % (e.g., about 2.0-6.0 wt %, about 6.0-10.0 wt %, about 10.0-14.0 wt %, about 14.0-18.0 wt %, or any other sub-range in the range of about 2.0-18.0 wt %). In some specific cases, the fly ash may have an initial carbon content in the range of about 8.0-14.0 wt %±3.0 wt % or about 10.0 wt %±3.0 wt %.

As can be seen from FIG. 1, method 100 may include, as in block 102, separating (e.g., classifying) the batch of fly ash into a plurality of distinguishable streams of dried fly ash. For instance, the incoming batch of fly ash may be separated into at least a first stream of dried fly ash and a separate and distinct second stream of dried fly ash. Separation in accordance with block 102 may be effectuated, in accordance with some embodiments, while drying the incoming batch of fly ash. Such drying may be performed in a continuous or non-continuous manner, as desired, utilizing any suitable dryer(s) (e.g., one or more rotary dryers), as will be apparent in light of this disclosure.

After drying, the resultant stream(s) of dried fly ash may have a moisture content in the range of about 5.0 wt % or less (e.g., about 4.0 wt % or less, about 3.0 wt % or less, about 2.0 wt % or less, about 1.0 wt % or less, about 0.5 wt % or less, about 0.1 wt % or less, or any other sub-range in the range of about 5.0 wt % or less). In some specific cases, the resultant dried fly ash may have a moisture content in the range of about 1.5 wt %±0.5 wt %. In some specific cases, the resultant dried fly ash may have a maximum moisture content of about 1.0 wt %±0.25 wt %.

To achieve targeted moisture content ranges, the applied temperature and duration of drying utilized to effectuate separation in accordance with block 102 may be customized, as desired for a given target application or end-use. In some cases, drying may be performed at a burner temperature in the range of about 1,000-2,000° F. (e.g., about 1,000-1,250° F., about 1,250-1,500° F., about 1,500-1,750° F., about 1,750-2,000° F., or any other sub-range in the range of about 1,000-2,000° F.). In some specific cases, drying may be performed at a burner temperature in the range of about 1,100-1,800° F. In some cases, drying may be performed at a single, relatively constant burner temperature or burner temperature range (e.g., about 1,500° F.±50° F.), whereas in other cases, a temperature profile including staged application of two or more different burner temperatures or burner temperature ranges may be employed. In some cases, drying may be performed for a period in the range of about 30 min or less (e.g., about 20 min or less, about 10 min or less, or any other sub-range in the range of about 30 min or less). In some cases, drying may be performed for a period in the range of about 1-10 min, about 5-15 min, about 10-20 min, about 15-25 min, or about 20-30 min.

In accordance with some embodiments, the first stream of dried fly ash may have a carbon content which is lower than that of the incoming fly ash, whereas the second stream of dried fly ash may have a carbon content which is equal to or greater than that of the incoming fly ash. For example, in some cases, the carbon content of the first stream may be between 0.75-1.25 points lower than that of the incoming batch of fly ash received at block 102, whereas the carbon content of the second stream may be between 1.0-3.0 points higher than that of that incoming batch of fly ash. In some instances, the carbon content of the first stream may be in the range of about 2.0-18.0 wt % (e.g., about 2.0-6.0 wt %, about 6.0-10.0 wt %, about 10.0-14.0 wt %, about 14.0-18.0 wt %, or any other sub-range in the range of about 2.0-18.0 wt %). In some specific cases, the carbon content of the first stream may be in the range of about 5.0-10.0 wt %±3.0 wt %. In some instances, the carbon content of the second stream may be in the range of about 3.0-20.0 wt % (e.g., about 3.0-9.0 wt %, about 9.0-15.0 wt %, about 15.0-20.0 wt %, or any other sub-range in the range of about 3.0-20.0 wt %). In some specific cases, the carbon content of the second stream may be in the range of about 6.0-15.0 wt %±3.0 wt %.

In accordance with some embodiments, the first stream of dried fly ash may be (or otherwise may include) baghouse fines—that is, particles which would be retained, for instance, on a 325-mesh screen—whereas the second stream of dried fly ash may be (or otherwise may include) dryer bottoms—that is, material(s) which would not be classified as baghouse fines. In accordance with some embodiments, the first stream of dried fly ash may have a fines content which is less than that of the incoming fly ash. For example, in some cases, the fines content of the first stream may be in the range of about 10.0-34.0 wt % (e.g., about 10.0-16.0 wt %, about 16.0-22.0 wt %, about 22.0-28.0 wt %, about 28.0-34.0 wt %, or any other sub-range in the range of about 10.0-34.0 wt %). In some specific cases, the fines content of the first stream may be in the range of about 18.0 wt %±8.0 wt %. In accordance with some embodiments, the second stream of dried fly ash may have an average particle size which is greater than that of the incoming fly ash. For example, in some cases, the second stream may have an average particle size in the range of about 15-1,000 μm (e.g., about 15-250 μm, about 250-500 μm, about 500-750 μm, about 750-1,000 μm, or any other sub-range in the range of about 15-1,000 μm). In some specific cases, the second stream may have an average particle size in the range of about 300-650 μm±200 μm or about 200-500 μm±100 μm. As will be appreciated in light of this disclosure, if the average particle size of the second stream of dried fly ash is greater than a given target range (e.g., greater than 34%), additional screening, classifying, and/or grinding may be performed on the second stream to achieve target fineness levels.

In accordance with some embodiments, prior to separation as in block 102, incoming batch of fly ash optionally may be pre-screened (e.g., prior to drying). For instance, in some cases, the incoming fly ash may be pre-screened to a size in the range of about 0.25-0.75 in (e.g., about 0.25-0.5 in, about 0.5-0.75 in, or any other sub-range in the range of about 0.25-0.75 in). In some cases, the incoming fly ash may be pre-screened to a size in the range of about 0.5 in±0.15 in.

As can be seen further from FIG. 1, method 100 may include, as in block 104, classifying the second stream of dried fly ash. Classifying may be performed in a continuous or non-continuous manner, as desired, utilizing any suitable technique(s) and system(s) (e.g., one or more air classifiers), as will be apparent in light of this disclosure. Classifying the second stream of dried fly ash in accordance with block 104 may serve, at least in part, to remove oversized particles therefrom. For instance, the second stream may be classified to remove particles having a size in the range of about 15.0 μm or greater (e.g., about 30.0 μm or greater, about 45.0 μm or greater, about 60.0 μm or greater, or any other sub-range in the range of about 15.0 μm or greater). Classifying the second stream of dried fly ash in accordance with block 104 also may serve, at least in part, to remove bottom ash—that is, granular, incombustible residue that settles at the bottom of coal-burning furnaces or incinerators, which is mostly made up of clinkers and unburned material too large to be carried in the air stream of boilers.

As can be seen further from FIG. 1, method 100 may include, as in block 106, thermally treating the resultant (e.g., dried and classified) second stream of dried fly ash to reduce a carbon content thereof. Thermal treatment may be performed in a continuous or non-continuous manner, as desired, utilizing any suitable thermal treatment technique(s) and system(s), as will be apparent in light of this disclosure. For instance, in accordance with some embodiments, a carbon offloading system may be utilized to thermally treat the second stream of fly ash by raising it to a sufficiently high temperature to burn off carbon under a supply of ambient oxygen.

Before thermal treatment in accordance with block 106, the incoming second stream of classified and dried fly ash may have a carbon content in the range of about 3.0-20.0 wt % (e.g., about 3.0-9.0 wt %, about 9.0-15.0 wt %, about 15.0-20.0 wt %, or any other sub-range in the range of about 3.0-20.0 wt %). In some specific cases, the incoming second stream of classified and dried fly ash may have a carbon content in the range of about 6.0-15.0 wt %±3.0 wt %. After thermal treatment, however, the resultant second stream may have a carbon content in the range of about 4.0 wt % or less (e.g., about 3.0 wt % or less, about 2.0 wt % or less, about 1.0 wt % or less, about 0.5 wt % or less, about 0.1 wt % or less, or any other sub-range in the range of about 4.0 wt % or less). In some specific cases, the classified and thermally treated second stream of dried fly ash may have a carbon content in the range of about 2.5 wt %±0.75 wt %, about 2.5 wt %±0.5 wt %, or about 2.5 wt %±0.25 wt %.

To achieve targeted carbon content ranges, the applied temperature and duration of the thermal treatment at block 106 may be customized, as desired for a given target application or end-use. In some cases, thermal treatment may be performed at a temperature in the range of about 1,000-1,800° F. (e.g., about 1,000-1,200° F., about 1,200-1,400° F., about 1,400-1,600° F., about 1,600-1,800° F., or any other sub-range in the range of about 1,000-1,800° F.). In some cases, thermal treatment may be performed at a temperature in the range of about 1,200° F.±150° F. In some cases, thermal treatment may be performed for a period in the range of about 240 min or less (e.g., about 180 min or less, about 120 min or less, about 60 min or less, or any other sub-range in the range of about 240 min or less). In some specific cases, thermal treatment may be performed for a period in the range of about 15-60 min, about 60-180 min, or about 180-240 min.

As can be seen further from FIG. 1, method 100 may include, as in block 108, mixing (e.g., recombining) (A) the first stream of dried fly ash (discussed above) and (B) the classified and thermally treated second stream of dried fly ash to produce (C) a processed fly ash mixture. Mixing may be performed in a continuous or non-continuous manner, as desired, utilizing any suitable mixing technique(s) and system(s), as will be apparent in light of this disclosure. After mixing, the resultant processed fly ash mixture may have a carbon content in the range of about 3.0-6.0 wt % (e.g., about 3.0-4.0 wt %, about 4.0-5.0 wt %, about 5.0-6.0 wt %, or any other sub-range in the range of about 3.0-6.0 wt %). In some specific cases, the resultant processed fly ash mixture may have a carbon content in the range of about 4.0 wt %±0.75 wt %, about 4.0 wt %±0.5 wt %, or about 4.0 wt %±0.25 wt %. Of course, other target carbon content ranges for the processed fly ash mixture produced according to method 100 may be achieved utilizing technique(s) and system(s) disclosed herein, in accordance with other embodiments.

As can be seen further from FIG. 1, method 100 optionally may include, as in block 110, adding one or more additives to the processed fly ash mixture. In some cases, only a single additive may be added, whereas in other cases, a plurality of additives may be added. Several suitable additives are discussed below, but other suitable additives will depend on a given target application or end-use and will be apparent in light of this disclosure. Addition of any such additive(s) may be done, for instance, if the processed fly ash mixture resulting from block 108 has a higher LOI than desired for a given target application or end-use.

In accordance with some embodiments, one or more liquid reagents may be added to the processed fly ash mixture in accordance with block 110. For example, in some cases, an additive which passivates the adsorption capacity of any unburned carbon content within the processed fly ash mixture before delivery may be added. More specifically, in at least some instances, a liquid reagent which pre-treats the processed fly ash mixture (e.g., before delivery to customers or other downstream uses) may be employed to adsorb preferentially onto carbon surfaces within that mixture and thus reduce an ability thereof to adsorb air entrainment agents in concrete. This in turn may improve the performance of the processed fly ash mixture, for example, when used in air-entrained concrete. In this manner, the effect of carbon on air entrainment in concrete may be neutralized (or otherwise reduced as desired), in accordance with some embodiments.

In some cases, an ethoxylated alcohol having (a) n-octanol-water partition coefficient (log K_{ow}) values in the range of −5 to +20, preferentially in the range of −2 to +2, and (b) hydrophilic-lipophilic balance (HLB) values in the range of −50 to +20 may be added. In some cases, a liquid reagent having the composition shown below in Table 1 may be added:

TABLE 1

| Constituent: | Amount (wt %): |
|---|---|
| Ethoxylated Alcohol | 40.0-80.0 |
| Propylene Glycol | 5.0-30.0 |
| Water | 10.0-30.0 |

In some cases, a liquid reagent comprising RestoreAir® liquid reagent, commercially available from Eco Material Technologies, Inc., of South Jordan, Utah, may be added. In some cases, block 110 may involve adding a liquid reagent such as that disclosed by U.S. Pat. No. 7,892,349, entitled “Sacrificial Agents for Fly Ash Concrete,” the disclosure of which is herein incorporated by reference in its entirety.

When optionally utilized, the amount of any such additive(s) applied to (e.g., sprayed onto) the processed fly ash mixture may be customized, as desired for a given target application or end-use. In some cases, the applied dosage of additive(s) to the processed fly ash mixture may be in the range of about 0.1-2.0 lbs./ton (e.g., about 0.1-0.5 lbs./ton, about 0.5-1.0 lbs./ton, about 1.0-1.5 lbs./ton, about 1.5-2.0 lbs./ton, or any other sub-range in the range of about 0.1-2.0 lbs./ton). Other suitable amounts for any such additive(s) will depend on a given target application or end-use and will be apparent in light of this disclosure.

Storage of the processed fly ash mixture resulting from method 100—or of any earlier or precursor forms thereof during a given constituent stage of method 100—optionally may be provided (e.g., via a silo or other suitable receptacle), in accordance with some embodiments. For instance, storage of fly ash which has been dried and classified in accordance with block 102 and/or block 104 may be provided, in accordance with some embodiments. Additionally (or alternatively), storage of processed fly ash mixture which has been thermally treated in accordance with block 106 but which has not yet had any additive(s) added thereto in accordance with block 110 may be provided, in accordance with some embodiments. Additionally (or alternatively), storage of the processed fly ash mixture which is produced by method 100 in full may be provided, in accordance with some embodiments. Intermediate and/or final storage may be provided utilizing any suitable storage means (e.g., silos, warehouses, trucks, etc.), as will be apparent in light of this disclosure.

### System Architectures and Example Operation Cases

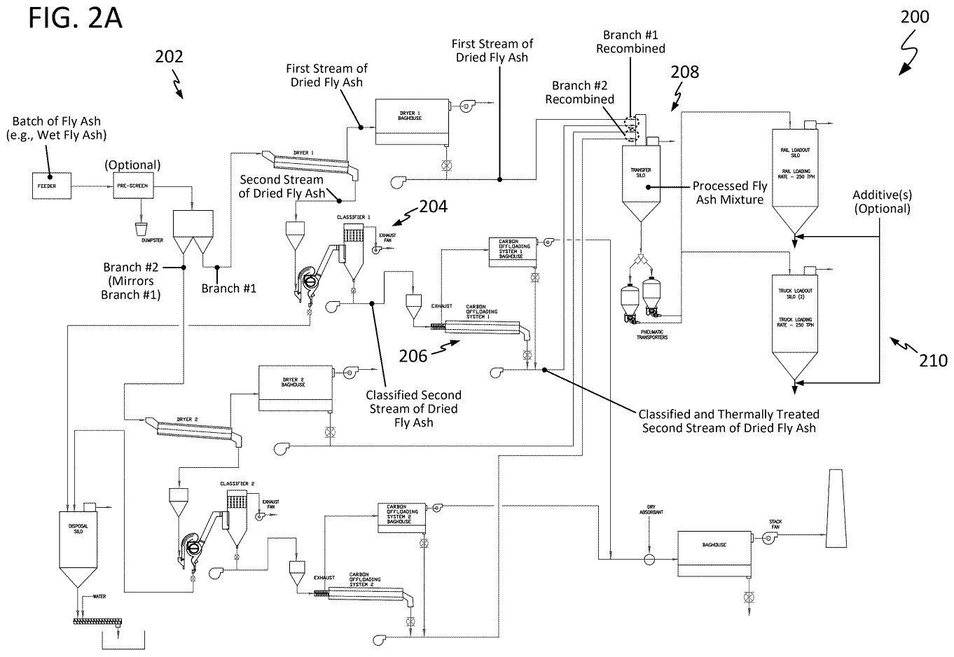

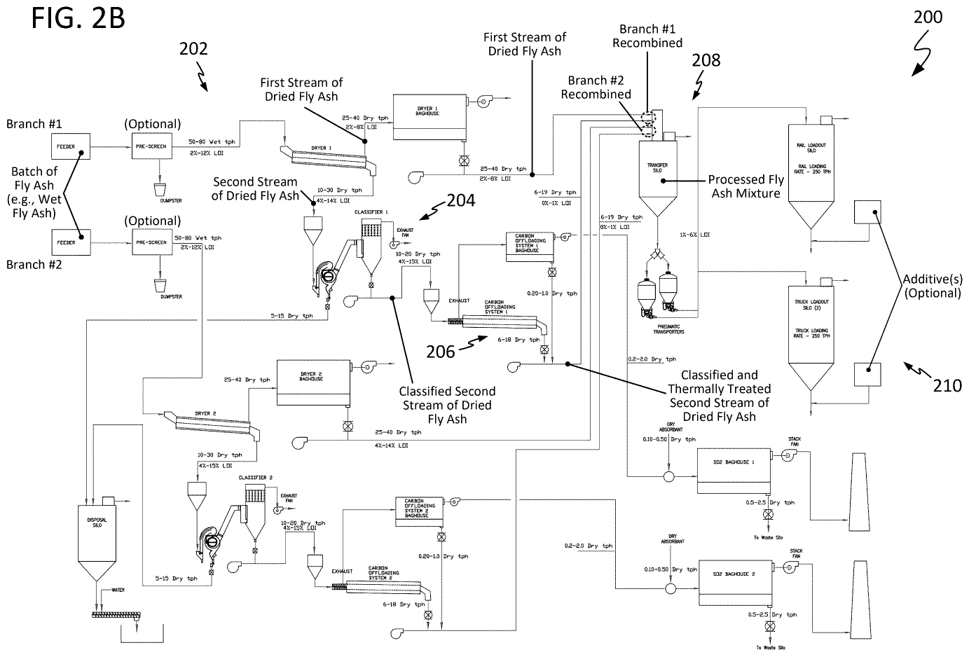

FIG. 2A is a process flow diagram illustrating a system 200 configured for processing fly ash to reduce a carbon content thereof, in accordance with an embodiment of the present disclosure. FIG. 2B is a process flow diagram illustrating a system 200 configured for processing fly ash to reduce a carbon content thereof, in accordance with another embodiment of the present disclosure. As can be seen from FIGS. 2A-2B, system 200 may include: (1) a first stage or module 202 configured to perform any of the various actions associated with block 102; (2) a second stage or module 204 configured to perform any of the various actions associated with block 104; (3) a third stage or module 206 configured to perform any of the various actions associated with block 106; (4) a fourth stage or module 208 configured to perform any of the various actions associated with block 108; and optionally (5) a fifth stage or module 210 configured to perform any of the various actions associated with block 110. As can be seen further in comparing system 200 across FIGS. 2A and 2B, system 200 of FIG. 2A utilizes a common raw ash feed for two separate lines (e.g., branches #1 and #2, as shown), whereas system 200 of FIG. 2B represents two completely separate processing lines (e.g., branches #1 and #2, as shown).

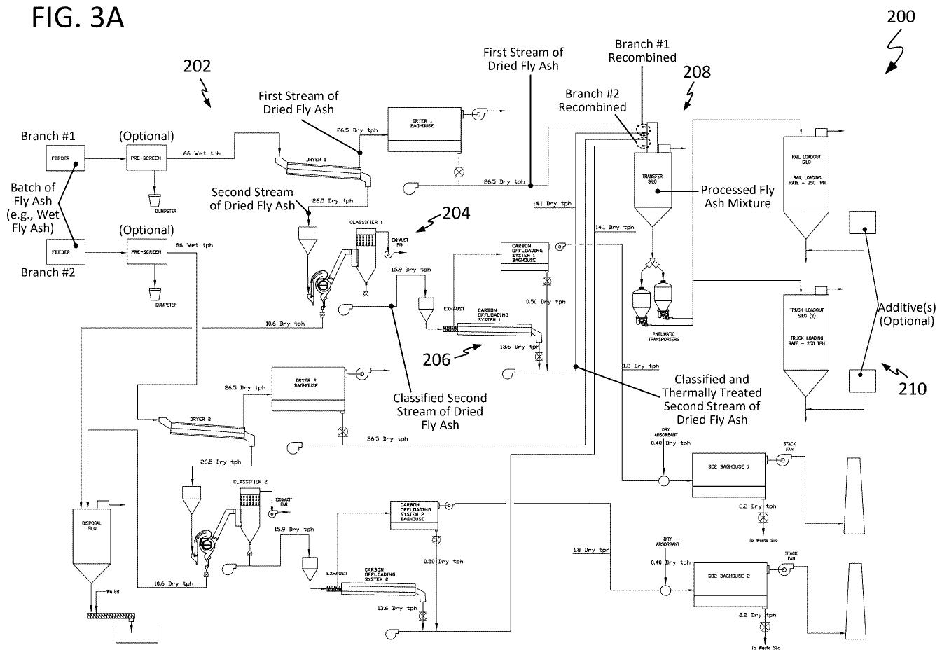

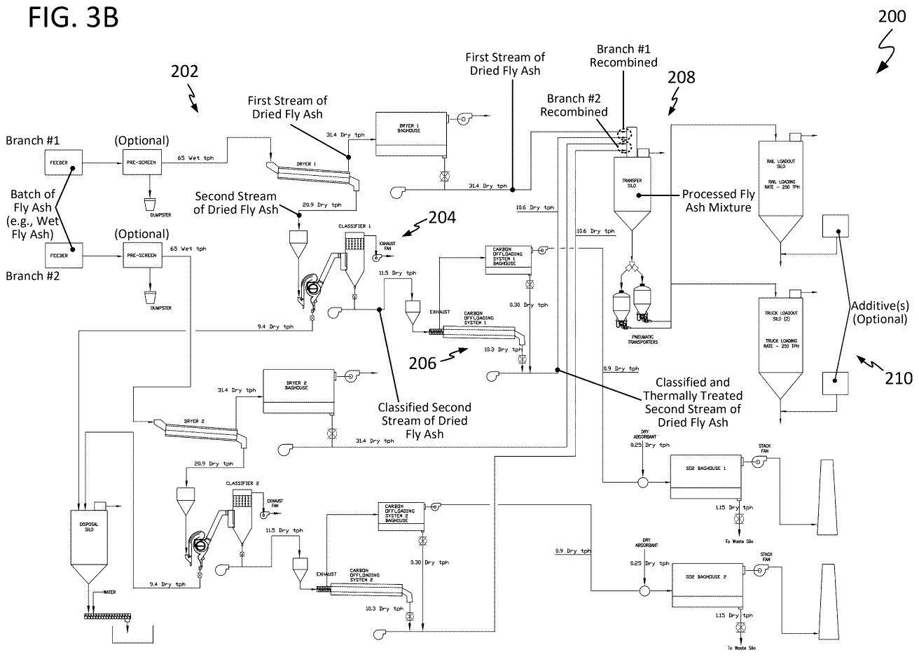

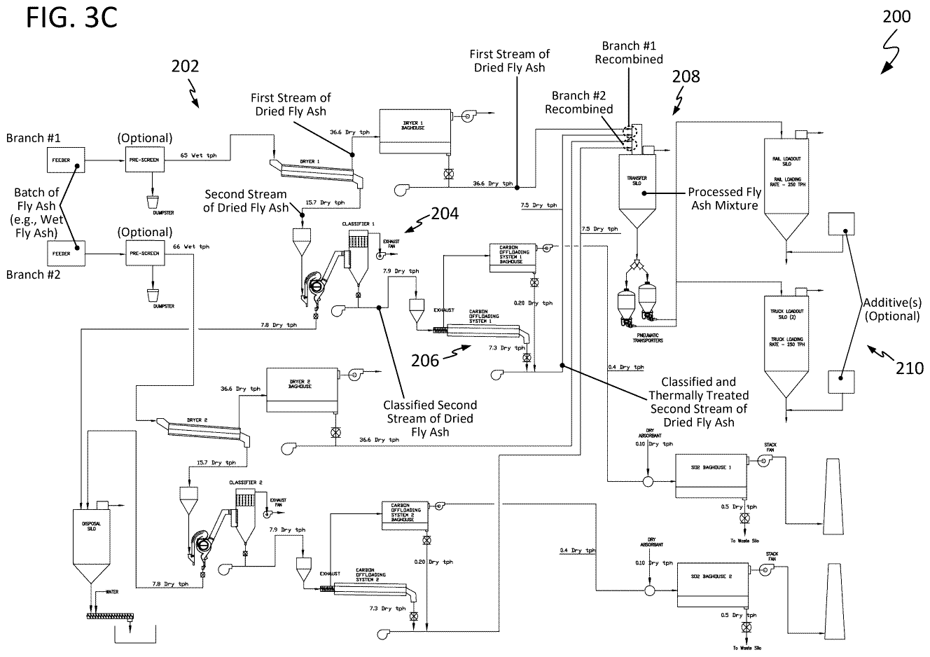

FIGS. 3A-3C are process flow diagrams illustrating three instances of operation of a system 200 on respective batches of raw fly ash having (A) a relatively high initial LOI of 10% with 50% dryer entrainment, (B) an average initial LOI of 6% with 60% dryer entrainment, and (C) a relatively low initial LOI of 4% with 70% dryer entrainment, in accordance with some embodiments of the present disclosure.

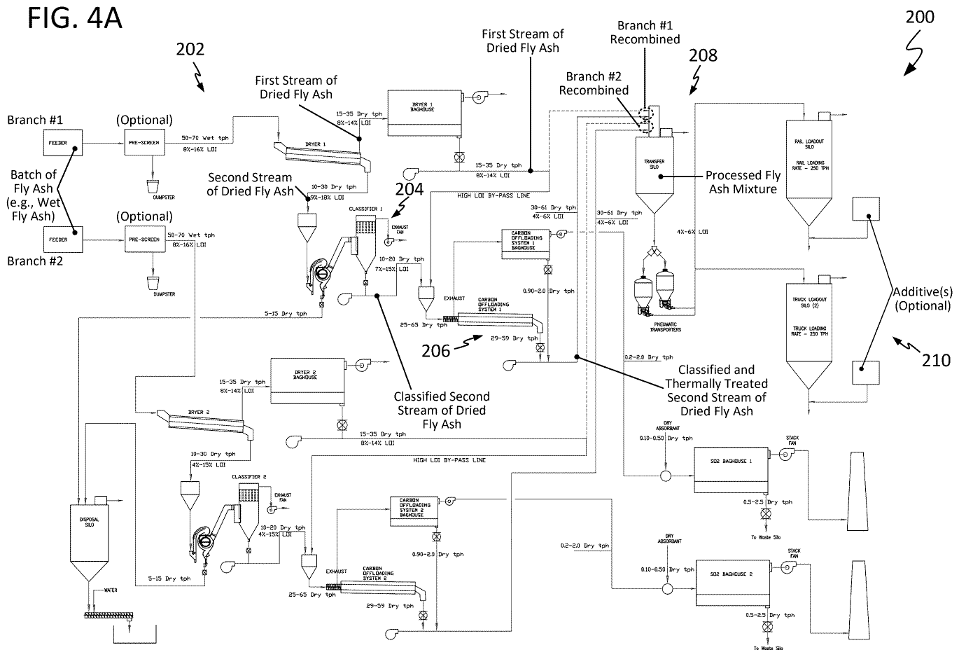

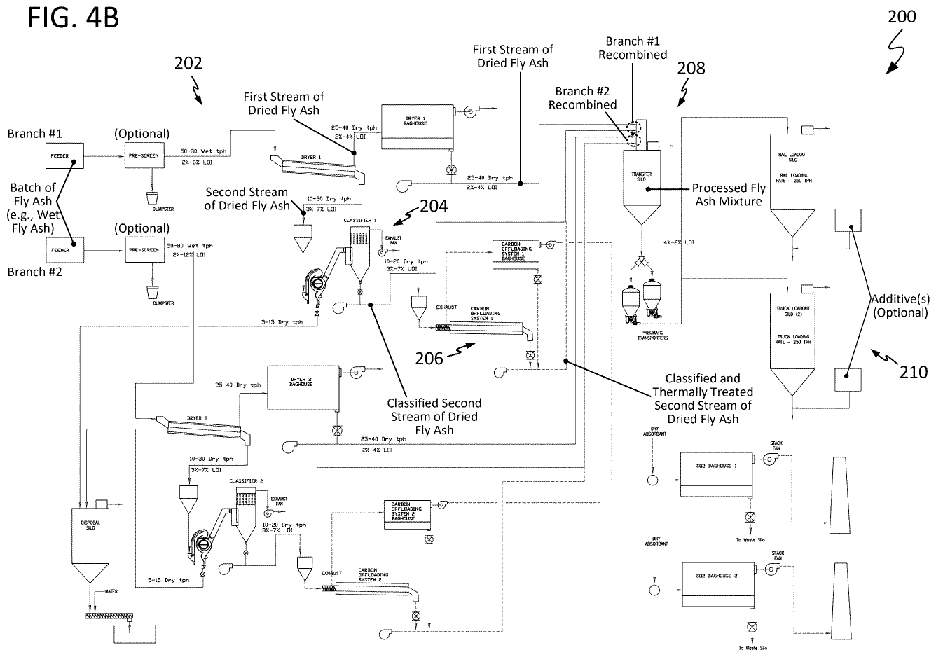

FIGS. 4A-4B are process flow diagrams illustrating two instances of operation of a system 200 on respective batches of fly ash having (A) a relatively high initial LOI vs. (B) a relatively low initial LOI, in accordance with some embodiments of the present disclosure. By way of non-limiting example, the fly ash encountered in FIG. 4A may have a relatively high initial LOI value, for instance, in the range of about 8.0-16.0 wt %, whereas the fly ash encountered in FIG. 4B may have a relatively low initial LOI value, for instance, in the range of about 2.0-6.0 wt %.

### FURTHER EXAMPLES

The following examples pertain to some further embodiments of the disclosure, from which numerous permutations and combinations will be apparent.

Example 1 includes a method. The method includes separating a batch of fly ash into a first stream of dried fly ash and a second stream of dried fly ash. The method further includes classifying the second stream of dried fly ash. The method further includes thermally treating the classified second stream of dried fly ash to reduce a carbon content thereof. The method further includes mixing the first stream of dried fly ash and the classified and thermally treated second stream of dried fly ash to produce a processed fly ash mixture.

Example 2 includes the subject matter of any of Examples 1 and 3-54, wherein the first stream of dried fly ash has a carbon content which is lower than that of the batch of fly ash.

Example 3 includes the subject matter of any of Examples 1-2 and 4-54, wherein the first stream of dried fly ash has a carbon content that is 0.75-1.25 points lower than that of the batch of fly ash.

Example 4 includes the subject matter of any of Examples 1-3 and 5-54, wherein the first stream of dried fly ash has a carbon content in the range of about 2.0-18.0 wt %.

Example 5 includes the subject matter of any of Examples 1-4 and 6-54, wherein the first stream of dried fly ash has a carbon content in the range of about 5.0-10.0 wt %±3.0 wt %.

Example 6 includes the subject matter of any of Examples 1-5 and 7-54, wherein the first stream of dried fly ash has a fines content which is less than that of the batch of fly ash.

Example 7 includes the subject matter of any of Examples 1-6 and 8-54, wherein the first stream of dried fly ash has a fines content in the range of about 10.0-34.0 wt %.

Example 8 includes the subject matter of any of Examples 1-7 and 9-54, wherein the first stream of dried fly ash has a fines content of about 18.0 wt %±8.0 wt %.

Example 9 includes the subject matter of any of Examples 1-8 and 10-54, wherein the first stream of dried fly ash consists essentially of particles that do not pass through a 325-mesh screen.

Example 10 includes the subject matter of any of Examples 1-9 and 11-54, wherein the carbon content of the second stream of dried fly ash is equal to or greater than that of the batch of fly ash.

Example 11 includes the subject matter of any of Examples 1-10 and 12-54, wherein the carbon content of the second stream of dried fly ash is in the range of about 3.0-20.0 wt %.

Example 12 includes the subject matter of any of Examples 1-11 and 13-54, wherein the carbon content of the second stream of dried fly ash is in the range of about 6.0-15.0 wt %±3.0 wt %.

Example 13 includes the subject matter of any of Examples 1-12 and 14-54, wherein the carbon content of the second stream of dried fly ash is 1.0-3.0 points higher than that of the batch of fly ash.

Example 14 includes the subject matter of any of Examples 1-13 and 15-54, wherein: the first stream of dried fly ash has a carbon content in the range of about 2.0-18.0 wt %; and the carbon content of the second stream of dried fly ash is in the range of about 3.0-20.0 wt %.

Example 15 includes the subject matter of any of Examples 1-14 and 16-54, wherein: the first stream of dried fly ash has a carbon content in the range of about 5.0-10.0 wt %±3.0 wt %; and the carbon content of the second stream of dried fly ash is in the range of about 6.0-15.0 wt %±3.0 wt %.

Example 16 includes the subject matter of any of Examples 1-15 and 17-54, wherein before separating the batch of fly ash into the first stream of dried fly ash and the second stream of dried fly ash, the method further includes: drying the batch of fly ash.

Example 17 includes the subject matter of any of Examples 1-16 and 18-54, wherein at least one of: before drying, the batch of fly ash has a moisture content in the range of about 5.0-25.0 wt %; and after drying, the batch of fly ash has a moisture content in the range of about 5.0 wt % or less.

Example 18 includes the subject matter of any of Examples 1-17 and 19-54, wherein both: before drying, the batch of fly ash has a moisture content in the range of about 5.0-25.0 wt %; and after drying, the batch of fly ash has a moisture content in the range of about 5.0 wt % or less.

Example 19 includes the subject matter of any of Examples 1-18 and 20-54, wherein after drying, the batch of fly ash has a moisture content of about 1.5 wt %±0.5 wt %.

Example 20 includes the subject matter of any of Examples 1-19 and 21-54, wherein after drying, the batch of fly ash has a maximum moisture content of about 1.0 wt %±0.25 wt %.

Example 21 includes the subject matter of any of Examples 1-20 and 22-54, wherein drying the batch of fly ash at least one of: utilizes a rotary dryer; and is performed at a burner temperature in the range of about 1,000-2,000° F.

Example 22 includes the subject matter of any of Examples 1-21 and 23-54, wherein drying the batch of fly ash both: utilizes a rotary dryer; and is performed at a burner temperature in the range of about 1,000-2,000° F.

Example 23 includes the subject matter of any of Examples 1-22 and 24-54, wherein the burner temperature is in the range of about 1,100-1,800° F.

Example 24 includes the subject matter of any of Examples 1-23 and 25-54, wherein the burner temperature is in the range of about 1,500° F.±50° F.

Example 25 includes the subject matter of any of Examples 1-24 and 26-54, wherein before drying the batch of fly ash, the method further includes: screening the batch of fly ash.

Example 26 includes the subject matter of any of Examples 1-25 and 27-54, wherein the batch of fly ash is screened to a size in the range of about 0.25-0.75 in.

Example 27 includes the subject matter of any of Examples 1-26 and 28-54, wherein the batch of fly ash is screened to a size of about 0.5 in±0.15 in.

Example 28 includes the subject matter of any of Examples 1-27 and 29-54, wherein the second stream of dried fly ash is classified to remove particles having a size of about 15.0 μm or greater.

Example 29 includes the subject matter of any of Examples 1-28 and 30-54, wherein the second stream of dried fly ash is classified to remove particles having a size of about 30.0 μm or greater.

Example 30 includes the subject matter of any of Examples 1-29 and 31-54, wherein the second stream of dried fly ash is classified to remove particles having a size of about 45.0 μm or greater.

Example 31 includes the subject matter of any of Examples 1-30 and 32-54, wherein the second stream of dried fly ash is classified to remove particles having a size of about 60.0 μm or greater.

Example 32 includes the subject matter of any of Examples 1-31 and 33-54, wherein at least one of: the batch of fly ash has a carbon content in the range of about 2.0-18.0 wt %; and the carbon content of the classified and thermally treated second stream of dried fly ash is in the range of about 4.0 wt % or less.

Example 33 includes the subject matter of any of Examples 1-32 and 34-54, wherein both: the batch of fly ash has a carbon content in the range of about 2.0-18.0 wt %; and the carbon content of the classified and thermally treated second stream of dried fly ash is in the range of about 4.0 wt % or less.

Example 34 includes the subject matter of any of Examples 1-33 and 35-54, wherein the carbon content of the classified and thermally treated second stream of dried fly ash is about 2.5 wt %±0.75 wt %.

Example 35 includes the subject matter of any of Examples 1-34 and 36-54, wherein thermally treating the classified second stream of dried fly ash is performed at a burner temperature in the range of about 1,000-1,800° F.

Example 36 includes the subject matter of any of Examples 1-35 and 37-54, wherein thermally treating the classified second stream of dried fly ash is performed at a burner temperature of about 1,200° F.±150° F.

Example 37 includes the subject matter of any of Examples 1-36 and 38-54, wherein the processed fly ash mixture has a carbon content in the range of about 3.0-6.0 wt %.

Example 38 includes the subject matter of any of Examples 1-37 and 39-54, wherein the processed fly ash mixture has a carbon content in the range of about 4.0 wt %±0.75 wt %.

Example 39 includes the subject matter of any of Examples 1-38 and 40-54, wherein the method further includes adding at least one additive to the processed fly ash mixture.

Example 40 includes the subject matter of any of Examples 1-39 and 41-54, wherein adding the at least one additive to the processed fly ash mixture includes: spraying the at least one additive onto the processed fly ash mixture.

Example 41 includes the subject matter of any of Examples 1-40 and 42-54, wherein the at least one additive is added at a dosage in the range of about 0.1-2.0 lbs./ton of the processed fly ash mixture.

Example 42 includes the subject matter of any of Examples 1-41 and 43-54, wherein the at least one additive is configured to passivate an adsorption capacity of any unburned carbon content within the processed fly ash mixture.

Example 43 includes the subject matter of any of Examples 1-42 and 44-54, wherein the at least one additive is configured to preferentially adsorb onto carbon surfaces within the processed fly ash mixture and reduce an ability thereof to adsorb air entrainment agents in concrete.

Example 44 includes the subject matter of any of Examples 1-43 and 45-54, wherein the at least one additive includes a liquid reagent.

Example 45 includes the subject matter of any of Examples 1-44 and 46-54, wherein the at least one additive includes an ethoxylated alcohol.

Example 46 includes the subject matter of any of Examples 1-45 and 47-54, wherein the ethoxylated alcohol has at least one of: n-octanol-water partition coefficient (log K_{ow}) values in the range of −5 to +20; and hydrophilic-lipophilic balance (HLB) values in the range of −50 to +20.

Example 47 includes the subject matter of any of Examples 1-46 and 48-54, wherein the n-octanol-water partition coefficient (log K_{ow}) values are in the range of −2 to +2.

Example 48 includes the subject matter of any of Examples 1-47 and 49-54, wherein the ethoxylated alcohol has both: n-octanol-water partition coefficient (log K_{ow}) values in the range of −5 to +20; and hydrophilic-lipophilic balance (HLB) values in the range of −50 to +20.

Example 49 includes the subject matter of any of Examples 1-48 and 50-54, wherein the n-octanol-water partition coefficient (log K_{ow}) values are in the range of −2 to +2.

Example 50 includes the subject matter of any of Examples 1-49 and 51-54, wherein the at least one additive includes: an ethoxylated alcohol; and propylene glycol.

Example 51 includes the subject matter of any of Examples 1-50 and 52-54, wherein at least one of: the ethoxylated alcohol constitutes between 40.0-80.0 wt % of the at least one additive; and the propylene glycol constitutes between 5.0-30.0 wt % of the at least one additive.

Example 52 includes the subject matter of any of Examples 1-51 and 53-54, wherein both: the ethoxylated alcohol constitutes between 40.0-80.0 wt % of the at least one additive; and the propylene glycol constitutes between 5.0-30.0 wt % of the at least one additive.

Example 53 includes the subject matter of any of Examples 1-52 and 54, wherein the at least one additive further includes water.

Example 54 includes the subject matter of any of Examples 1-53, wherein the water constitutes between 10.0-30.0 wt % of the at least one additive.

Example 55 includes a system. The system includes a first stage or module configured to separate a batch of fly ash into a first stream of dried fly ash, and a second stream of dried fly ash. The system further includes a second stage or module configured to classify the second stream of dried fly ash. The system further includes a third stage or module configured to thermally treat the classified second stream of dried fly ash to reduce a carbon content thereof. The system further includes a fourth stage or module configured to mix the first stream of dried fly ash and the classified and thermally treated second stream of dried fly ash to produce a processed fly ash mixture.

Example 56 includes the subject matter of any of Examples 55 and 57-108, wherein the first stream of dried fly ash has a carbon content which is lower than that of the batch of fly ash.

Example 57 includes the subject matter of any of Examples 55-56 and 58-108, wherein the first stream of dried fly ash has a carbon content that is 0.75-1.25 points lower than that of the batch of fly ash.

Example 58 includes the subject matter of any of Examples 55-57 and 59-108, wherein the first stream of dried fly ash has a carbon content in the range of about 2.0-18.0 wt %.

Example 59 includes the subject matter of any of Examples 55-58 and 60-108, wherein the first stream of dried fly ash has a carbon content in the range of about 5.0-10.0 wt %±3.0 wt %.

Example 60 includes the subject matter of any of Examples 55-59 and 61-108, wherein the first stream of dried fly ash has a fines content which is less than that of the batch of fly ash.

Example 61 includes the subject matter of any of Examples 55-60 and 62-108, wherein the first stream of dried fly ash has a fines content in the range of about 10.0-34.0 wt %.

Example 62 includes the subject matter of any of Examples 55-61 and 63-108, wherein the first stream of dried fly ash has a fines content of about 18.0 wt %±8.0 wt %.

Example 63 includes the subject matter of any of Examples 55-62 and 64-108, wherein the first stream of dried fly ash consists essentially of particles that do not pass through a 325-mesh screen.

Example 64 includes the subject matter of any of Examples 55-63 and 65-108, wherein the carbon content of the second stream of dried fly ash is equal to or greater than that of the batch of fly ash.

Example 65 includes the subject matter of any of Examples 55-64 and 66-108, wherein the carbon content of the second stream of dried fly ash is in the range of about 3.0-20.0 wt %.

Example 66 includes the subject matter of any of Examples 55-65 and 67-108, wherein the carbon content of the second stream of dried fly ash is in the range of about 6.0-15.0 wt %±3.0 wt %.

Example 67 includes the subject matter of any of Examples 55-66 and 68-108, wherein the carbon content of the second stream of dried fly ash is 1.0-3.0 points higher than that of the batch of fly ash.

Example 68 includes the subject matter of any of Examples 55-67 and 69-108, wherein: the first stream of dried fly ash has a carbon content in the range of about 2.0-18.0 wt %; and the carbon content of the second stream of dried fly ash is in the range of about 3.0-20.0 wt %.

Example 69 includes the subject matter of any of Examples 55-68 and 70-108, wherein: the first stream of dried fly ash has a carbon content in the range of about 5.0-10.0 wt %±3.0 wt %; and the carbon content of the second stream of dried fly ash is in the range of about 6.0-15.0 wt %±3.0 wt %.

Example 70 includes the subject matter of any of Examples 55-69 and 71-108, wherein the first stage or module is further configured to dry the batch of fly ash before separating the batch of fly ash into the first stream of dried fly ash and the second stream of dried fly ash.

Example 71 includes the subject matter of any of Examples 55-70 and 72-108, wherein at least one of: before drying via the first stage or module, the batch of fly ash has a moisture content in the range of about 5.0-25.0 wt %; and after drying via the first stage or module, the batch of fly ash has a moisture content in the range of about 5.0 wt % or less.

Example 72 includes the subject matter of any of Examples 55-71 and 73-108, wherein both: before drying via the first stage or module, the batch of fly ash has a moisture content in the range of about 5.0-25.0 wt %; and after drying via the first stage or module, the batch of fly ash has a moisture content in the range of about 5.0 wt % or less.

Example 73 includes the subject matter of any of Examples 55-72 and 74-108, wherein after drying via the first stage or module, the batch of fly ash has a moisture content of about 1.5 wt %±0.5 wt %.

Example 74 includes the subject matter of any of Examples 55-73 and 75-108, wherein after drying via the first stage or module, the batch of fly ash has a maximum moisture content of about 1.0 wt %±0.25 wt %.

Example 75 includes the subject matter of any of Examples 55-74 and 76-108, wherein drying the batch of fly ash via the first stage or module at least one of: utilizes a rotary dryer; and is performed at a burner temperature in the range of about 1,000-2,000° F.

Example 76 includes the subject matter of any of Examples 55-75 and 77-108, wherein drying the batch of fly ash via the first stage or module both: utilizes a rotary dryer; and is performed at a burner temperature in the range of about 1,000-2,000° F.

Example 77 includes the subject matter of any of Examples 55-76 and 78-108, wherein the burner temperature is in the range of about 1,100-1,800° F.

Example 78 includes the subject matter of any of Examples 55-77 and 79-108, wherein the burner temperature is in the range of about 1,500° F.±50° F.

Example 79 includes the subject matter of any of Examples 55-78 and 80-108, wherein the first stage or module is further configured to screen the batch of fly ash before drying the batch of fly ash.

Example 80 includes the subject matter of any of Examples 55-79 and 81-108, wherein the batch of fly ash is screened via the first stage or module to a size in the range of about 0.25-0.75 in.

Example 81 includes the subject matter of any of Examples 55-80 and 82-108, wherein the batch of fly ash is screened via the first stage or module to a size of about 0.5 in±0.15 in.

Example 82 includes the subject matter of any of Examples 55-81 and 83-108, wherein the second stream of dried fly ash is classified via the second stage or module to remove particles having a size of about 15.0 μm or greater.

Example 83 includes the subject matter of any of Examples 55-82 and 84-108, wherein the second stream of dried fly ash is classified via the second stage or module to remove particles having a size of about 30.0 μm or greater.

Example 84 includes the subject matter of any of Examples 55-83 and 85-108, wherein the second stream of dried fly ash is classified via the second stage or module to remove particles having a size of about 45.0 μm or greater.

Example 85 includes the subject matter of any of Examples 55-84 and 86-108, wherein the second stream of dried fly ash is classified via the second stage or module to remove particles having a size of about 60.0 μm or greater.

Example 86 includes the subject matter of any of Examples 55-85 and 87-108, wherein at least one of: the batch of fly ash has a carbon content in the range of about 2.0-18.0 wt %; and the carbon content of the classified and thermally treated second stream of dried fly ash is in the range of about 4.0 wt % or less.

Example 87 includes the subject matter of any of Examples 55-86 and 88-108, wherein both: the batch of fly ash has a carbon content in the range of about 2.0-18.0 wt %; and the carbon content of the classified and thermally treated second stream of dried fly ash is in the range of about 4.0 wt % or less.

Example 88 includes the subject matter of any of Examples 55-87 and 89-108, wherein the carbon content of the classified and thermally treated second stream of dried fly ash is about 2.5 wt %±0.75 wt %.

Example 89 includes the subject matter of any of Examples 55-88 and 90-108, wherein thermally treating the classified second stream of dried fly ash via the third stage or module is performed at a burner temperature in the range of about 1,000-1,800° F.

Example 90 includes the subject matter of any of Examples 55-89 and 91-108, wherein thermally treating the classified second stream of dried fly ash via the third stage or module is performed at a burner temperature of about 1,200° F.±150° F.

Example 91 includes the subject matter of any of Examples 55-90 and 92-108, wherein the processed fly ash mixture has a carbon content in the range of about 3.0-6.0 wt %.

Example 92 includes the subject matter of any of Examples 55-91 and 93-108, wherein the processed fly ash mixture has a carbon content in the range of about 4.0 wt %±0.5 wt %.

Example 93 includes the subject matter of any of Examples 55-92 and 94-108, wherein the system further includes a fifth stage or module configured to add at least one additive to the processed fly ash mixture.

Example 94 includes the subject matter of any of Examples 55-93 and 95-108, wherein the fifth stage or module is configured to add the at least one additive to the processed fly ash mixture by spraying the at least one additive onto the processed fly ash mixture.

Example 95 includes the subject matter of any of Examples 55-94 and 96-108, wherein the at least one additive is added via the fifth stage or module at a dosage in the range of about 0.1-2.0 lbs./ton of the processed fly ash mixture.

Example 96 includes the subject matter of any of Examples 55-95 and 97-108, wherein the at least one additive is configured to passivate an adsorption capacity of any unburned carbon content within the processed fly ash mixture.

Example 97 includes the subject matter of any of Examples 55-96 and 98-108, wherein the at least one additive is configured to preferentially adsorb onto carbon surfaces within the processed fly ash mixture and reduce an ability thereof to adsorb air entrainment agents in concrete.

Example 98 includes the subject matter of any of Examples 55-97 and 99-108, wherein the at least one additive includes a liquid reagent.

Example 99 includes the subject matter of any of Examples 55-98 and 100-108, wherein the at least one additive includes an ethoxylated alcohol.

Example 100 includes the subject matter of any of Examples 55-99 and 101-108, wherein the ethoxylated alcohol has at least one of: n-octanol-water partition coefficient (log K_{ow}) values in the range of −5 to +20; and hydrophilic-lipophilic balance (HLB) values in the range of −50 to +20.

Example 101 includes the subject matter of any of Examples 55-100 and 102-108, wherein the n-octanol-water partition coefficient (log K_{ow}) values are in the range of −2 to +2.

Example 102 includes the subject matter of any of Examples 55-101 and 103-108, wherein the ethoxylated alcohol has both: n-octanol-water partition coefficient (log K_{ow}) values in the range of −5 to +20; and hydrophilic-lipophilic balance (HLB) values in the range of −50 to +20.

Example 103 includes the subject matter of any of Examples 55-102 and 104-108, wherein the n-octanol-water partition coefficient (log K_{ow}) values are in the range of −2 to +2.

Example 104 includes the subject matter of any of Examples 55-103 and 105-108, wherein the at least one additive includes: an ethoxylated alcohol; and propylene glycol.

Example 105 includes the subject matter of any of Examples 55-104 and 106-108, wherein at least one of: the ethoxylated alcohol constitutes between 40.0-80.0 wt % of the at least one additive; and the propylene glycol constitutes between 5.0-30.0 wt % of the at least one additive.

Example 106 includes the subject matter of any of Examples 55-105 and 107-108, wherein both: the ethoxylated alcohol constitutes between 40.0-80.0 wt % of the at least one additive; and the propylene glycol constitutes between 5.0-30.0 wt % of the at least one additive.

Example 107 includes the subject matter of any of Examples 55-106 and 108, wherein the at least one additive further includes water.

Example 108 includes the subject matter of any of Examples 55 to 107, wherein the water constitutes between 10.0-30.0 wt % of the at least one additive.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure not be limited by this detailed description. Future-filed applications claiming priority to this application may claim the disclosed subject matter in a different manner and generally may include any set of one or more limitations as variously disclosed or otherwise demonstrated herein.

What is claimed is:

1. A method comprising:
separating a batch of fly ash into:
a first stream of dried fly ash; and
a second stream of dried fly ash;
classifying the second stream of dried fly ash;
thermally treating the classified second stream of dried fly ash to reduce a carbon content thereof; and
mixing the first stream of dried fly ash and the classified and thermally treated second stream of dried fly ash to produce a processed fly ash mixture.

2. The method of claim 1, wherein:
the first stream of dried fly ash has a carbon content that is 0.75-1.25 points lower than that of the batch of fly ash; and
the carbon content of the second stream of dried fly ash is 1.0-3.0 points higher than that of the batch of fly ash.

3. The method of claim 1, wherein:
the first stream of dried fly ash has a carbon content in the range of about 2.0-18.0 wt %; and
the carbon content of the second stream of dried fly ash is in the range of about 3.0-20.0 wt %.

4. The method of claim 1, wherein before separating the batch of fly ash into the first stream of dried fly ash and the second stream of dried fly ash, the method further comprises:
drying the batch of fly ash, wherein:
before drying, the batch of fly ash has a moisture content in the range of about 5.0-25.0 wt %; and
after drying, the batch of fly ash has a moisture content in the range of about 5.0 wt % or less.

5. The method of claim 4, wherein drying the batch of fly ash both:
utilizes a rotary dryer; and
is performed at a burner temperature in the range of about 1,000-2,000° F.

6. The method of claim 4, wherein before drying the batch of fly ash, the method further comprises:
screening the batch of fly ash, wherein the batch of fly ash is screened to a size in the range of about 0.25-0.75 in.

7. The method of claim 1, wherein the second stream of dried fly ash is classified to remove particles having a size of about 15.0 μm or greater.

8. The method of claim 1, wherein both:
the batch of fly ash has a carbon content in the range of about 2.0-18.0 wt %; and
the carbon content of the classified and thermally treated second stream of dried fly ash is in the range of about 4.0 wt % or less.

9. The method of claim 1, wherein thermally treating the classified second stream of dried fly ash is performed at a burner temperature in the range of about 1,000-1,800° F.

10. The method of claim 1, wherein the processed fly ash mixture has a carbon content in the range of about 3.0-6.0 wt %.

11. The method of claim 1, further comprising:
adding at least one additive to the processed fly ash mixture, wherein the at least one additive is configured to at least one of:
passivate an adsorption capacity of any unburned carbon content within the processed fly ash mixture; and
preferentially adsorb onto carbon surfaces within the processed fly ash mixture and reduce an ability thereof to adsorb air entrainment agents in concrete.

12. The method of claim 11, wherein:
the at least one additive comprises:
an ethoxylated alcohol; and
propylene glycol;
the ethoxylated alcohol constitutes between 40.0-80.0 wt % of the at least one additive; and
the propylene glycol constitutes between 5.0-30.0 wt % of the at least one additive.

13. A system comprising:
a first stage or module configured to separate a batch of fly ash into:
a first stream of dried fly ash; and
a second stream of dried fly ash;
a second stage or module configured to classify the second stream of dried fly ash;
a third stage or module configured to thermally treat the classified second stream of dried fly ash to reduce a carbon content thereof; and
a fourth stage or module configured to mix the first stream of dried fly ash and the classified and thermally treated second stream of dried fly ash to produce a processed fly ash mixture.

14. The system of claim 13, wherein:
the first stream of dried fly ash has a carbon content that is 0.75-1.25 points lower than that of the batch of fly ash; and
the carbon content of the second stream of dried fly ash is 1.0-3.0 points higher than that of the batch of fly ash.

15. The system of claim 13, wherein:
the first stream of dried fly ash has a carbon content in the range of about 2.0-18.0 wt %; and
the carbon content of the second stream of dried fly ash is in the range of about 3.0-20.0 wt %.

16. The system of claim 13, wherein the first stage or module is further configured to dry the batch of fly ash before separating the batch of fly ash into the first stream of dried fly ash and the second stream of dried fly ash, wherein both:
before drying via the first stage or module, the batch of fly ash has a moisture content in the range of about 5.0-25.0 wt %; and
after drying via the first stage or module, the batch of fly ash has a moisture content in the range of about 5.0 wt % or less.

17. The system of claim 16, wherein drying the batch of fly ash via the first stage or module both:
utilizes a rotary dryer; and
is performed at a burner temperature in the range of about 1,000-2,000° F.

18. The system of claim 16, wherein the first stage or module is further configured to screen the batch of fly ash before drying the batch of fly ash, wherein the batch of fly ash is screened via the first stage or module to a size in the range of about 0.25-0.75 in.

19. The system of claim 13, wherein the second stream of dried fly ash is classified via the second stage or module to remove particles having a size of about 15.0 μm or greater.

20. The system of claim 13, wherein both:
the batch of fly ash has a carbon content in the range of about 2.0-18.0 wt %; and
the carbon content of the classified and thermally treated second stream of dried fly ash is in the range of about 4.0 wt % or less.

21. The system of claim 13, wherein thermally treating the classified second stream of dried fly ash via the third stage or module is performed at a burner temperature in the range of about 1,000-1,800° F.

22. The system of claim 13, wherein the processed fly ash mixture has a carbon content in the range of about 3.0-6.0 wt %.

23. The system of claim 13, further comprising a fifth stage or module configured to add at least one additive to the processed fly ash mixture, wherein the at least one additive is configured to at least one of:
passivate an adsorption capacity of any unburned carbon content within the processed fly ash mixture; and
preferentially adsorb onto carbon surfaces within the processed fly ash mixture and reduce an ability thereof to adsorb air entrainment agents in concrete.

24. The system of claim 23, wherein:
the at least one additive comprises:
an ethoxylated alcohol; and
propylene glycol;
the ethoxylated alcohol constitutes between 40.0-80.0 wt % of the at least one additive; and
the propylene glycol constitutes between 5.0-30.0 wt % of the at least one additive.
